(19) United States
(12) Patent Application Publication
(10) Pub. No.: US 2024/0320356 A1
(43) Pub. Date: Sep. 26, 2024

(54) FILE SYSTEM DATA ACCESS CONTROL METHOD, COMPUTER-READABLE STORAGE MEDIUM AND DATA STORAGE DEVICE

(71) Applicant: QNAP Systems, Inc., New Taipei City (TW)

(72) Inventor: Chin-Hsing HSU, New Taipei City (TW)

(21) Appl. No.: 18/235,060

(22) Filed: Aug. 17, 2023

(30) Foreign Application Priority Data
Mar. 23, 2023 (TW) 112110967

(51) Int. Cl. G06F 21/62; G06F 16/188

(52) U.S. Cl. CPC G06F 21/6218; G06F 16/188

(57) ABSTRACT

A file system data access control method, a corresponding computer-readable storage medium and a corresponding data storage device are provided. The method is used in a file system of the data storage device and includes: setting an access rule that specifies a directory in the file system; setting a label into a security context of a virtual inode of the directory, wherein, if a process of an application is going to modify the directory, checking whether the label is already set in a security context of a task structure of the process; if the label is already set in the security context of the task structure, allowing the process to modify the directory, otherwise disallowing the process from modifying the directory.

### BACKGROUND

### 1. Technical Field

The present disclosure relates to a data access control technology, and in particular to a technology for controlling the access to backup data.

### 2. Description of Related Art

Ransomware and malware are becoming more and more rampant, and their attacks have been occurring one after another, resulting in the loss of data or property of enterprises or individuals. In this regard, in addition to strengthening the information security of network devices and servers, emphasis should also be put on the security protection of backup data to prevent important backup data from being attacked by ransomware or being deleted or modified by malware.

### SUMMARY

In order to address the above and other problems, the present disclosure provides a file system data access control method, which applied in a file system of a data storage device. The file system data access control method includes: setting an access rule, wherein the access rule specifies a directory in the file system; setting a label into a security context of a virtual inode of the directory; when a process of an application is going to modify the directory, checking whether the label is already set in a security context of a task structure of the process; and when the label is already set in the security context of the task structure, allowing the process to modify the directory; otherwise, disallowing the process from modifying the directory.

Moreover, the present disclosure provides a file system data access control method, which is executed by at least one processor, processing unit or logic unit of a data storage device and applied in a file system of the data storage device. The file system data access control method includes: setting an access rule, wherein the access rule specifies a directory in the file system; setting a label into a security context of a virtual inode of the directory; when a process of an application is going to modify the directory, checking whether the label is already set in a security context of a task structure of the process; and when the label is already set in the security context of the task structure, allowing the process to modify the directory; otherwise, disallowing the process from modifying the directory.

Further, the present disclosure provides a file system data access control method, which is executed by at least one processor of a data storage device and applied in a file system of the data storage device. The file system data access control method includes: setting, by the at least one processor, an access rule, wherein the access rule specifies a directory in the file system; setting, by the at least one processor, a label into a security context of a virtual inode of the directory; when a process of an application is going to modify the directory, checking, by the at least one processor, whether the label is already set in a security context of a task structure of the process; and when the label is already set in the security context of the task structure, allowing, by the at least one processor, the process to modify the directory; otherwise, disallowing, by the at least one processor, the process from modifying the directory.

The present disclosure further provides a computer-readable storage medium configured to store instructions to be read by a data storage device to execute the aforementioned file system data access control method.

Moreover, the present disclosure provides a non-transitory computer-readable storage medium storing instructions to be read by a data storage device to execute the aforementioned file system data access control method.

The present disclosure further provides a data storage device comprising an operating system and a file system, wherein the operating system is configured to execute the aforementioned file system data access control method in the file system.

Moreover, the present disclosure provides a data storage device comprising a file system and at least one processor, processing unit or logic unit, wherein the at least one processor, processing unit or logic unit is configured to execute the aforementioned file system data access control method in the file system.

The file system data access control method of the present disclosure can protect backup data or general data to effectively prevent ransomware attacks, effectively prevent deletion or modification by malware, and enhance system security without affecting system performance.

### BRIEF DESCRIPTION OF THE DRAWINGS

The present disclosure can be more fully understood by reading the following descriptions of the embodiments, with reference made to the accompanying drawings.

FIG. 1 is a schematic diagram of a directory entry cache and virtual index nodes according to an embodiment of the present disclosure.

FIG. 2 and FIG. 3 are schematic diagrams of a directory entry cache, virtual index nodes and the other related data structure during the execution of a file system data access control method according to an embodiment of the present disclosure.

FIG. 4 is a block diagram of a data storage device according to an embodiment of the present disclosure.

### DETAILED DESCRIPTION OF THE EMBODIMENTS

The following examples are used for illustrating the present disclosure. A person skilled in the art can easily conceive the other advantages and effects of the present disclosure, based on the disclosure of the specification. The present disclosure can also be implemented or applied as described in different examples. It is possible to modify or alter the following examples for carrying out this disclosure without contravening its spirit and scope, for different aspects and applications.

The technical solution in the present disclosure can be applied to, e.g., an Linux operating system installed in a data storage device. The data storage device may be an electronic device with data processing and storage functions such as a computer or a server.

Linux divides a file system into two layers, namely, a virtual file system (VFS) and a physical file system. The virtual file system of Linux belongs to a software layer in the kernel of Linux, which is a software abstraction layer implemented on top of the physical file system. The virtual file system of Linux is used to receive system calls related to the file system and forward those system calls to the physical file system. In addition, Linux supports a variety of physical file systems, such as the common ext2, ext3, ext4, and xfs file systems.

The index nodes (inodes) of the Linux file system are divided into the inodes of the virtual file system (abbreviated as virtual inodes) and the inodes of the physical file system (abbreviated as physical inodes).

A virtual inode is a data structure that exists only in the dynamic random access memory (DRAM) of the data storage device. Each virtual inode corresponds to or represents a directory, a regular file, a device file, or a special file of another type in the Linux operating system.

For a directory or a file, a virtual inode can be used to store metadata related to the directory or the file. In addition, metadata is descriptive data about the attributes of a directory or a file, and may include the name, the type, the time of modification of the directory or the file, and a pointer to the physical inode of the directory or the file.

The physical file system and the physical directories, physical files, and physical inodes within the physical file system are all stored in a non-volatile storage of the data storage device, such as one or more non-volatile disks, one or more flash drives, or one or more non-volatile memories.

A directory entry (dentry) of the virtual file system is another data structure that exists only in the DRAM of the data storage device. Each dentry corresponds to or represents a directory in a file path or the file at the end of the file path.

The Linux operating system has a dentry cache in the DRAM of the data storage device. The dentry cache is used to store the path structure of the directory tree in the file system. When a process executed by the data storage device needs to open a file, the dentries in the dentry cache can be used to speed up the querying of the file.

For example, in the file path “/home/hbs/backup1/dir1/file1”, each of “home”, “hbs”, “backup1”, “dir1” and “file1” has a corresponding dentry. When the file “/home/hbs/backup1/dir1/file1” is opened for the first time and the dentries of the file path do not yet exist in the dentry cache, Linux queries the physical file system and then create those dentries in the order of “home”, “hbs”, “backup1”, “dir1” and “file1” for operations after this opening. The dentries can be used to speed up the search for the same file when it is opened again later, since there is no need to query the physical file system again.

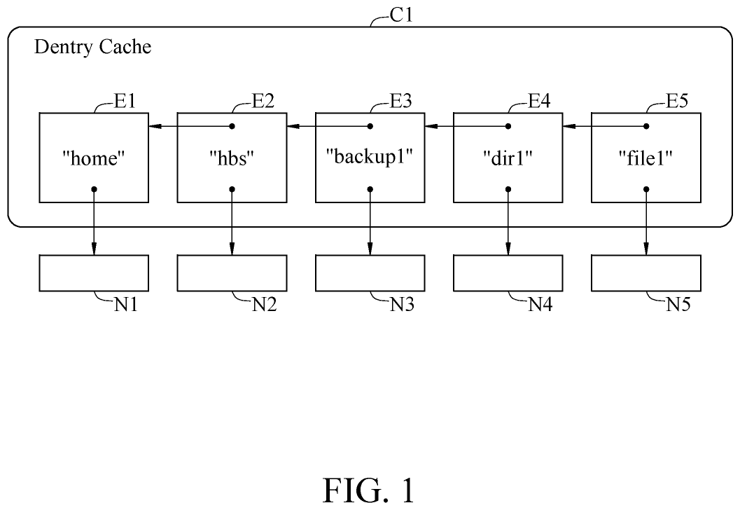

Each dentry (e.g., E1 as shown in FIG. 1) contains the name of the corresponding directory or the corresponding file, the memory address of the virtual inode of the corresponding directory or the corresponding file, and a pointer to the dentry (e.g., E2) of the parent directory of that dentry (e.g., E1).

In addition, the dentry of each directory may also contain additional pointers to the dentries of each sub-directory and each file in that directory.

FIG. 1 shows an embodiment of the dentry cache and the virtual inodes in the DRAM of the data storage device, which illustrates five dentries E1-E5 corresponding to the file path “/home/hbs/backup1/dir1/file1” in the dentry cache C1 and the virtual inodes N1-N5 of the directories and the file corresponding to the dentries E1-E5.

Linux Security Module (LSM) is a framework in the Linux kernel for supporting various computer security models. LSM provides the functions required for mandatory access control (MAC) and provides a mechanism enabling multiple security checks to run simultaneously in the Linux kernel while minimizing modifications to the Linux kernel.

LSM provides a memory block known as security context for each task structure (also known as “task struct”) and each virtual inode in the Linux kernel, so that various security model implementations can store their respective information in the security context.

The present disclosure provides a file system data access control method, which is a MAC mechanism running in the Linux kernel and implemented based on the LSM framework. The file system data access control method may be implemented as a software module (hereinafter referred to as the MAC module) in the Linux kernel and is applicable to various Linux file systems. The following describes the technical contents of the file system data access control method of the present disclosure.

The MAC module provides a user mode application programming interface (API) for the processes of executed applications to send setting instructions to the MAC module to set access rules. Each access rule specifies an application and a directory in the file system of the data storage device so that the directory and all directories and all files under that directory can only be modified by the process of that application. The aforementioned applications are stored in the file system of the data storage device as executable files.

When a process of an application sets an access rule through the user mode API of the MAC module to specify the application and a directory, the MAC module selects a unique label for the access rule. The label corresponds to and only to the access rule.

In addition, the MAC module sets the label into the security context of the virtual inode of the directory, removes the dentries of all directories and all files under that directory from the dentry cache, sets the label into the security context of the virtual inode of the application, and sets the dentries of the directory and the application to be resident in the dentry cache (i.e., the resident dentries will not be removed from the dentry cache by the Linux kernel).

When multiple access rules are set by one or more processes of one or more applications, the MAC module handles each access rule as described above, wherein the MAC module selects a unique label for each access rule and ensures that each label corresponds to a different access rule.

When any application is executed, the instructions in the application are loaded into the DRAM of the data storage device to create a process of the application. Linux sets up a corresponding task structure in its kernel for each thread of the process. Each task structure is used to store the execution states and the other execution-related information of the corresponding thread.

The MAC module sets all the labels in the security context of the virtual inode of the application into the security context of each task structure of the process of the application.

When any directory or any file is created or opened, Linux creates the dentry of the directory or the file. When a dentry is created, the security context of the virtual inode to which the dentry points inherits all the labels in the security context of the virtual inode to which the parent dentry of the dentry points.

When the security context of the virtual inode of a directory or a file has at least one label, and the process created when an application is executed is going to modify the directory or the file, the MAC module checks whether at least one of the at least one label is already set in the security context of the task structure of the process.

When at least one of the at least one label is already set in the security context of the task structure, the MAC module allows the process to modify the directory or the file, otherwise the MAC module disallows the process from modifying the directory or the file.

On the other hand, when the security context of the virtual inode of a directory or a file does not include any label, then the MAC module allows any process to modify the directory or the file.

In addition to the setting instruction, the process of an application may also send an removing instruction to the MAC module through the user mode API to remove the application or a directory from an access rule (i.e., remove the protection of the access rule on the application or the directory).

When a directory is removed from an access rule, the MAC module removes the label corresponding to the access rule from the security context of the virtual inode of the directory, and removes all dentries of the directory tree whose root node is the directory (i.e., the directory tree formed by that directory itself and all directories and all files under that directory) from the dentry cache.

When a file is removed from an access rule, the MAC module removes the label corresponding to the access rule from the security context of the virtual inode of the file, and removes the dentry of the file from the dentry cache.

When an application is removed from an access rule, the MAC module removes the label corresponding to the access rule from the security context of the virtual inode of the application, and sets the dentry of the application to be no longer resident in the dentry cache. After that, Linux decides whether to remove the dentry of the application from the dentry cache according to the dentry cache algorithm.

If an application is a data backup application, it may store the backup data obtained from backups performed at each different time point in different directory trees. Before each backup, the application may first create the root directory of the directory tree for this backup, and set an access rule to specify the application and the root directory, so that only the process of the application can modify the directory tree, and then the process of the application may start to store the backup data in the directory tree.

Therefore, a directory tree may contain all directory structures and all file data contents of a backup, and different directory trees of different backups may be different sub-trees of a larger directory tree. The MAC module may select a different unique label for each different access rule of each backup and set the label for each backup into the security context of the virtual inode of the data backup application for that backup, and set the same label into the security contexts of the virtual inodes of all directories and all files of the directory tree of that backup. After that, the MAC module may execute the access control of all the directories and files of each directory tree according to the label of each access rule.

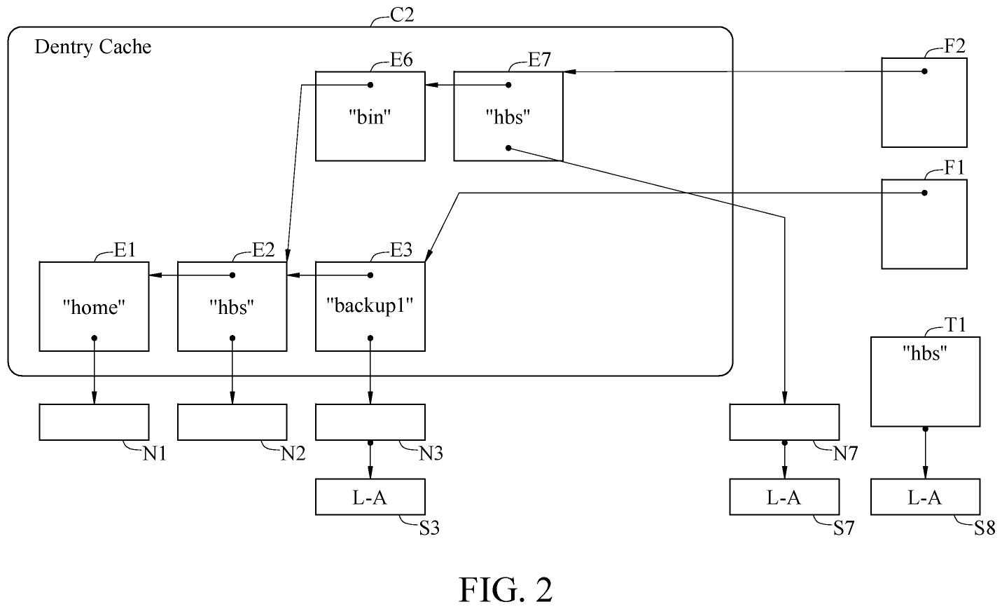

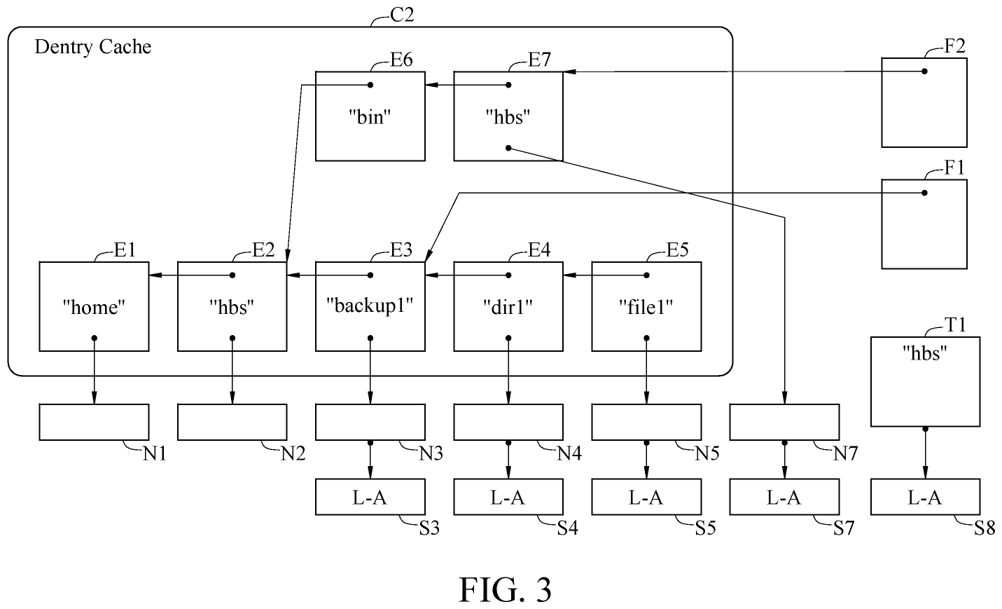

FIG. 2 and FIG. 3 illustrate a dentry cache, virtual inodes and the other related data structure during the execution of a file system data access control method of an embodiment of the present disclosure.

In this embodiment, an application in a file system of the data storage device is a data backup application whose executable file “/home/hbs/bin/hbs” corresponds to the dentries E1, E2, E6 and E7 in the dentry cache C2. The data backup application is going to execute the latest backup and store the latest backup data in the directory “/home/hbs/backup1” corresponding to the dentries E1-E3 in the dentry cache C2. The flow of the file system data access control method of this embodiment is described in detail below.

First, the process of the data backup application sends a setting instruction through the user mode API of the MAC module to set an access rule specifying the directory “/home/hbs/backup1” and the data backup application, so that the directory “/home/hbs/backup1” can only be modified by the process of the data backup application.

After receiving the setting instruction, the MAC module opens the directory “/home/hbs/backup1”. In the Linux operating system, when a directory or a file is opened, a corresponding data structure (hereinafter called “file structure”) is created in the Linux kernel to store information about the directory or the file after it is opened, such as the memory address of the dentry of the directory or the file.

The file structure of the opened directory “/home/hbs/backup1” is F1. Therefore, the MAC module can find the dentry E3 and the virtual inode N3 of the directory “/home/hbs/backup1” through the file structure F1, select the unique label L-A for the access rule, and then set the label L-A into the security context S3 of the virtual inode N3, as shown in FIG. 2.

The MAC module sets the dentry E3 to be resident in the dentry cache C2. A resident dentry is never removed from the dentry cache and the virtual inode pointed to by the dentry is also always resident in the memory unless the directory or the file corresponding to the dentry is deleted.

In addition, the MAC module removes the dentries of all directories and all files under the directory “/home/hbs/backup1” from the dentry cache C2. In this way, when the directories and files under the directory “/home/hbs/backup1” are accessed, the label L-A is inherited into the security contexts of the virtual inodes of these directories and files.

Next, the MAC module opens the data backup application, i.e., opens the executable file “/home/hbs/bin/hbs”, and finds the dentry E7 and the virtual inode N7 of the executable file through the file structure F2 of the executable file, and then sets the label L-A into the security context S7 of the virtual inode N7, as shown in FIG. 2.

In addition, the MAC module sets the dentry E7 to be resident in the dentry cache C2, and the virtual inode N7 is also be resident in memory.

Next, the executable file “/home/hbs/bin/hbs” is executed and the MAC module sets the label L-A in the security context S7 of its virtual inode N7 into the security context S8 of the task structure T1 stored in the Linux kernel and corresponding to the process derived from the executable file, as shown in FIG. 2.

Each virtual inode and its security context are respectively stored at separate memory addresses. Each virtual inode contains a pointer to the security context of that virtual inode. In addition, each task structure and its security context are also respectively stored at separate memory addresses. Each task structure contains a pointer to the security context of that task structure.

Next, the process of the data backup application creates the directory “/home/hbs/backup1/dir1”. Since the security context S8 of the task structure T1 of the process of the data backup application also includes the label L-A, the MAC module allows the process of the data backup application to create the directory “dir1”. The virtual file system creates the virtual inode N4 and the dentry E4 for the directory “dir1”.

Moreover, the MAC module obtains the label L-A in the security context S3 of the virtual inode N3 via the parent dentry E3 of dentry E4, and then sets the label L-A into the security context S4 of the virtual inode N4, as shown in FIG. 3.

Next, the process of the data backup application further creates the file “file1” in the directory “dir1”. Since the security context S4 of the virtual inode N4 of the directory “dir1” includes the label L-A, and the security context S8 of the task structure T1 also includes the label L-A, the MAC module allows the process of the data backup application to create the file “file1” in the directory “dir1”. The virtual file system creates the virtual inode N5 and the dentry E5 for the file “file1”.

Furthermore, the MAC module obtains the label L-A in the security context S4 of the virtual inode N4 via the parent dentry E4 of the dentry E5, and then sets the label L-A into the security context S5 of the virtual inode N5, as shown in FIG. 3.

At this moment, only the process of the data backup application having the label L-A can modify the directory “/home/hbs/backup1” and the directories and files therein, which also has the label L-A. The other applications cannot modify the directory “/home/hbs/backup1” or any directory or any file therein because the other applications do not have the label L-A.

The dentries E4 and E5 are not forced to be resident in the dentry cache C2. Therefore, when the Linux operating system needs more memory, the dentries E4 and E5 may be removed to free up memory. Later, when a process of another application accesses the path “/home/hbs/backup1/dir1/file1”, the dentries E4 and E5 of the directory “dir1” and the file “file1” are created again and inherit the label L-A from the security context S3 of the virtual inode N3 pointed to by the dentry E3.

In the aforementioned embodiments, the file system data access control method of the present disclosure is applied to the Linux operating system, but the present disclosure is not limited thereto. In another embodiment, all operating systems with the various data structures and their corresponding mechanisms shown in FIG. 3 can adopt the file system data access control method of the present disclosure.

In an embodiment, the present disclosure further provides a computer-readable storage medium, such as a memory, a magnetic disk or an optical disk. The computer-readable storage medium can be used to store instructions that can be read by the aforementioned data storage device to execute the aforementioned file system data access control method.

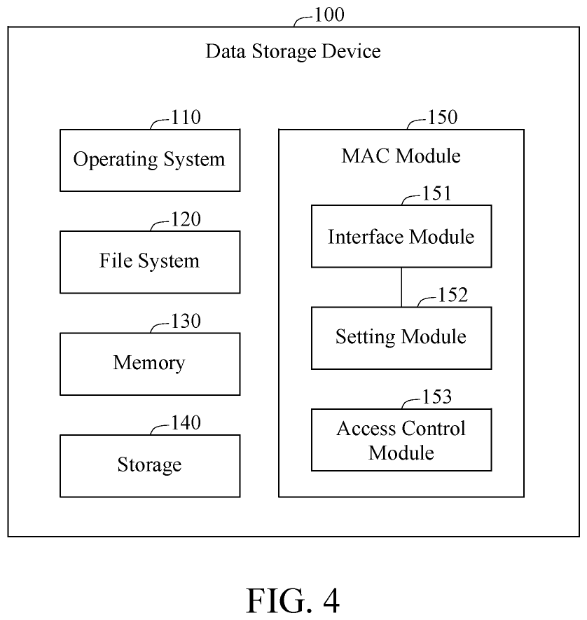

FIG. 4 shows a block diagram of a data storage device 100 of an embodiment of the present disclosure. In this embodiment, the data storage device 100 includes an operating system 110, a file system 120, a memory 130, a storage 140, and a MAC module 150. The operating system 110 may be, for example, a Linux operating system. The file system 120 may include the aforementioned physical file system and virtual file system. Both of the operating system 110 and the file system 120 may be implemented as software or firmware. The memory 130 may be, for example, a DRAM for storing data structures such as the virtual inodes, the dentries, the dentry cache, the task structures, the file structures, and the security contexts in each aforementioned embodiment. The storage 140 may be a non-volatile storage as described above and configured to store the aforementioned physical file system, including the physical directories, the physical files and the physical inodes in the physical file system. The MAC module 150 is configured to execute the file system data access control method of each of the above embodiments.

Any two of the operating system 110, the file system 120, the memory 130, and the MAC module 150 are communicatively connected to each other, and the storage 140 is communicatively connected to the operating system 110, the file system 120, and the memory 130. These connections are omitted in FIG. 4 in order to simplify the drawing.

The MAC module 150 in FIG. 4 is shown as an independent module separate from the operating system 110, but the present disclosure is not limited thereto. In another embodiment, the MAC module may be implemented as a software module in the kernel of the operating system 110.

The MAC module 150 includes an interface module 151, a setting module 152, and an access control module 153, wherein the interface module 151 and the setting module 152 are communicatively connected to each other. The interface module 151, the setting module 152, and the access control module 153 may be implemented as software, firmware, or hardware, and if implemented as hardware, they may be implemented as at least one processor, wherein each processor includes at least one processing core, processing unit or logic unit with the function of executing program instructions. Alternatively, if the interface module 151, the setting module 152 and the access control module 153 are implemented as software or firmware, the data storage device 100 may further include at least one aforementioned processor, processing unit or logic unit and the interface module 151, the setting module 152 and the access control module 153 may be executed by the at least one processor, processing unit or logic unit of the data storage device 100.

The interface module 151 may provide a user mode API for receiving the setting instructions and the removing instructions in each aforementioned embodiment.

The setting module 152 is configured to perform various setting procedures in each aforementioned embodiment, such as: selecting a unique label for each access rule and setting the label into the security context of the corresponding virtual inode; whenever a dentry is created, arranging the security context of the virtual inode to which the dentry points inherits all the labels in the security context of the virtual inode to which the parent dentry of that dentry points; setting all the labels in the security context of the virtual inode of an application that has just been executed into the security context of each task structure of the process of the application; removing the label corresponding to an access rule from the security context of a virtual inode; setting a dentry to be resident in the dentry cache; setting a dentry to be no longer resident in the dentry cache; and removing a dentry from the dentry cache.

When a process of an application is going to modify a directory or a file, the access control module 153 may check the security context of the task structure of the process and the label in the security context of the virtual inode of the directory or the file to allow the process to modify the directory or the file or disallow the process from modifying the directory or the file. When the access control module 153 allows the process to modify the directory or the file, the process modifies the directory or the file in the physical file system stored in the storage 140 through the virtual file system.

The file system data access control method of the present disclosure is implemented in the kernel of the operating system. Through the user mode API, a backup application can flexibly select the backup data to be protected and flexibly adjust the scope of protection, so as to prevent the backup data from being attacked by ransomware, or to prevent malware from deleting or modifying the backup data.

Moreover, through the user mode API, the backup application can remove the protection in a timely manner according to management requirements. In addition, the access rules of the present disclosure are applied in the security contexts of virtual inodes in DRAM, and are not stored in physical inodes. Therefore, the access rules do not occupy physical storage space or affect system performance.

Furthermore, the present disclosure has the following advantages compared with various conventional technologies.

Firstly, the write once read many (WORM) protection mechanism in existing file systems can be used to protect backup data because the protected data are read-only after being written, so it can prevent deletion and tampering, but some file systems do not have this function, so they cannot use WORM to protect backup data. In addition, WORM usually needs to set the retention period, and no data can be modified before the expiration of the retention period, which limits the flexibility of backups. Once the backup policy is changed, the backup data that does not comply with the policy cannot not be deleted in time. In addition, after the backup is completed and before WORM starts, an unprotected time window may appear and the backup data may be attacked during this window.

In contrast, the technical solution of the present disclosure is applicable to any file system and can protect backup data in various file systems. Moreover, the present disclosure does not need to set a retention period and thus does not limit the flexibility of backup. In addition, the present disclosure can set an access rule before data backup. Therefore, the unprotected window of WORM never occurs in the present disclosure.

Secondly, the discretionary access control (DAC) mechanism of the existing operating systems may cause the backup files to be accessed accidentally by other software because the backup application or system administrator may set insecure read/write permissions. In addition, since the root user (ROOT) has the highest permission level, if a program runs with root user permission or the permission of the program is improperly elevated due to security vulnerability, the program would be able to circumvent the DAC and access backup data freely. Therefore, the DAC cannot achieve effective access control.

In contrast, the present disclosure performs access control based on the unique label selected and set by the MAC module, so there is no accidental mis-setting of read/write permissions. Moreover, regardless of the identity or the permission of the user of a program, even a program running with root user identity cannot circumvent the label check of the MAC module of the present disclosure. Therefore, the present disclosure can achieve effective access control.

Thirdly, due to the above problems, the existing Linux operating systems provide two MAC mechanisms, namely, Application Armor (AppArmor) and Security-Enhanced Linux (SELinux), to complement the deficiencies of the DAC. The targets of control of AppArmor are the file paths of programs in order to control which resources and which files can be accessed by the programs, but programs not set with access rules are not controlled by AppArmor. Since ransomware can be a file under any path in the file system and can have any file name, ransomware can easily evade the control of AppArmor. Furthermore, AppArmor sets access control on the paths of programs, so it is easy to use the symbolic link or the bind mount of the Linux operating system to circumvent the control of AppArmor.

In contrast, the present disclosure binds the label of an access rule to a virtual inode for access control, instead of deciding whether to apply the access rule according to the path or the name of a program. Therefore, all programs that do not have the label, under any path or with any file name, cannot modify the directories or the files protected by the label, and the access control of the present disclosure cannot be circumvented even by using the symbolic link or the bind mount of the Linux operating system.

Fourthly, the targets of control of SELinux are also programs, and SELinux disallows programs not set with access rules from accessing any data. Such a high level of security control often accidentally denies programs from access and causes administrative problems. Therefore, this function is often turned off by system administrators and is virtually useless.

In contrast, the present disclosure does not deny a program not specified in an access rule from any data access, but only denies access by a program not specified in an access rule to a directory or a file that has been specified in the access rule, and thus does not accidentally deny access by a program and does not cause administrative problems.

In addition to being applied to backup applications to protect backup data, the technical solution of the present disclosure can also be applied to the other types of programs or software to control access to general data.

While some of the embodiments of the present disclosure have been described in detail above, it is, however, possible for those of ordinary skill in the art to make various modifications and changes to the particular embodiments shown without substantially departing from the teaching and advantages of the present disclosure. Such modifications and changes are encompassed in the spirit and scope of the present disclosure as set forth in the appended claims.

What is claimed is:

1. A file system data access control method, executed by at least one processor of a data storage device and applied in a file system of the data storage device, the file system data access control method comprising:
setting, by the at least one processor, an access rule, wherein the access rule specifies a first directory in the file system;
setting, by the at least one processor, a label into a security context of a virtual inode of the first directory;
when a first process of a first application is going to modify the first directory, checking, by the at least one processor, whether the label is already set in a security context of a task structure of the first process; and
when the label is already set in the security context of the task structure, allowing, by the at least one processor, the first process to modify the first directory; otherwise, disallowing, by the at least one processor, the first process from modifying the first directory.

2. The file system data access control method of claim 1, further comprising:
removing, by the at least one processor, dentries of all directories and all files under the first directory from a dentry cache of an operating system of the data storage device; and
setting, by the at least one processor, a dentry of the first directory to be resident in the dentry cache.

3. The file system data access control method of claim 1, further comprising:
removing, by the at least one processor, the label from the security context of the virtual inode of the first directory; and
removing, by the at least one processor, all dentries of a directory tree whose root node is the first directory from a dentry cache of an operating system of the data storage device to remove the first directory from the access rule.

4. The file system data access control method of claim 1, further comprising:
when a second directory or a file under the first directory is created or opened, setting, by the at least one processor, the label into a security context of a virtual inode of the second directory or the file;
when a second process of a second application is going to modify the second directory or the file, checking, by the at least one processor, whether the label is already set in a security context of a task structure of the second process; and
when the label is already set in the security context of the task structure of the second process, allowing, by the at least one processor, the second process to modify the second directory or the file; otherwise, disallowing, by the at least one processor, the second process from modifying the second directory or the file.

5. The file system data access control method of claim 1, wherein when the label is already set in the security context of the task structure of the first process, the access rule specifies the first application and the first directory, and the file system data access control method further comprises:
setting, by the at least one processor, dentries of the first directory and the first application to be resident in a dentry cache of an operating system of the data storage device;
setting, by the at least one processor, the label into a security context of a virtual inode of the first application; and
when the at least one processor runs the first application, setting, by the at least one processor, the label in the security context of the virtual inode of the first application into the security context of the task structure of the first process.

6. The file system data access control method of claim 5, further comprising:
removing, by the at least one processor, the label from the security context of the virtual inode of the first application and setting the dentry of the first application to be no longer resident in the dentry cache to remove the first application from the access rule.

7. The file system data access control method of claim 1, further comprising:
setting, by the at least one processor, a plurality of access rules, wherein each of the access rules specifies a directory or a file in the file system;
selecting, by the at least one processor, a label for each of the access rules, and then setting, by the at least one processor, the label into a security context of a virtual inode of the directory or the file specified in the access rule, wherein the labels of the access rules are all different;
when a third process of a third application is going to modify one of the directories and the files, checking, by the at least one processor, whether at least one of the labels is already set in a security context of a task structure of the third process; and
when at least one of the labels is already set in the security context of the task structure of the third process, allowing, by the at least one processor, the third process to modify the directory or the file; otherwise, disallowing, by the at least one processor, the third process from modifying the directory or the file.

8. The file system data access control method of claim 7, wherein
each of the access rules specifies a backup application in the file system and one of the directories;
each of the directories is a root directory of a different directory tree;
the backup application specified in each of the access rules uses the directory tree of the directory specified in the access rule to store backup data of the backup application; and
each of the directory trees is used to store backup data of different time points, and the file system data access control method further comprises:
setting, by the at least one processor, the label of each of the access rules into a security context of a virtual inode of the backup application specified in the access rule, and setting, by the at least one processor, the label into security contexts of virtual inodes of all directories and all files in the directory tree corresponding to the access rule; and
performing, by the at least one processor, access control of all directories and all files of each of the directory trees according to the label of each of the access rules.

9. A non-transitory computer-readable storage medium storing instructions to be read by a data storage device to execute the file system data access control method according to claim 1.

10. A data storage device comprising a file system and at least one processor, wherein the at least one processor is configured to execute the file system data access control method according to claim 1 in the file system.
